(19) United States
(12) Patent Application Publication
(10) Pub. No.: US 2012/0037753 A1
(43) Pub. Date: Feb. 16, 2012

(54) LATERAL GUIDE, LATERAL GUIDE ASSEMBLY, CARGO DECK

(75) Inventors: Thomas HUBER, Schliersee (DE); Richard HOLZNER, Stephanskirchen (DE)

(73) Assignee: Telair International GmbH, Miesbach (DE)

(21) Appl. No.: 13/208,101

(22) Filed: Aug. 11, 2011

(30) Foreign Application Priority Data
Aug. 13, 2010 (DE) 10 2010 036 983.7

(51) Int. Cl. B64C 1/22

(52) U.S. Cl. 244/118.1

(57) ABSTRACT

The present invention relates to a lateral guide for guiding cargo items in an aircraft. Such lateral guides are used to guide containers or pallets during their transport from the tail to the nose and to secure them in their final position. The proposed lateral guide has a mounting frame extending in the longitudinal direction and at least one lateral guide device having a sliding carriage, whereby the lateral guide device is movably supported in the mounting frame in the longitudinal direction. The sliding carriage has at least one guide roller for supporting the cargo items.

### CROSS-REFERENCE TO RELATED APPLICATIONS

This application claims priority of German patent application no. 10 2010 036 983.7, filed Aug. 13, 2010, the disclosure of which is incorporated herein by reference in its entirety.

### FIELD OF THE INVENTION

The invention relates to a lateral guide for guiding cargo items, a lateral guide assembly having a plurality of corresponding lateral guides and a cargo deck equipped with a corresponding lateral guide or lateral guide assembly.

### BACKGROUND OF THE INVENTION

It is known that holds of aircraft are frequently converted for different purposes. It may be necessary, for example, to configure a cargo deck depending on the cargo items to be loaded. When transporting loads in aircraft, cargo items, e.g. containers or pallets, with standardised dimensions are frequently used. So for containers, for example, there are the following standard sizes: 123.5 by 317.5 cm (88 inch×125 inch), 143.8 cm by 317.5 cm (96 inch×125 inch), 223.5 cm by 157.5 cm (88 inch×62 inch). Pallets measuring 274.3 cm by 223.5 cm (108 inch×88 inch) are frequently used in the military sector. Lateral guides mounted on the cargo deck are used to secure and guide such standardised cargo items. For best utilisation of cargo hold it is necessary to offer a plurality of potential configurations whereby high priority is given to rapid conversion of the cargo deck. Suitable lateral guides must be quickly and easily attachable and reconfigurable since the costs for operating relevant aircraft are very high. It should also be very easy to carry out the reconfiguration because the staff carrying out this reconfiguration have frequently had no or only very poor training for the cargo decks used. Added to this is the fact that the lateral guides have to be very rugged as they are exposed to very high loads and it is not possible to demand low impact handling due to the severe time pressure prevailing during loading and unloading. A cargo deck with corresponding lateral guides is frequently exposed to wetness, extreme differences in temperature, dust and other rough external effects. A faulty cargo deck—even a faulty functional element of the cargo deck—may result in the relevant aircraft being unusable for several days. Such a breakdown is very expensive.

The equipping of an aircraft's cargo deck is very noticeable in the aircraft's overall weight which means that it is desirable to save weight in this area.

EP 1 179 472 A2 discloses lateral guides which make it possible to reconfigure a cargo deck quickly and easily such that different cargo items with a variety of dimensions can be loaded. The lateral guides used therein can be lowered in part such that other lateral guides provided for this purpose can take over the guiding and attachment function. One disadvantage of the cargo deck described in EP 1 179 472 A2 is that reconfiguration is sometimes very time-consuming. Moreover, a plurality of functional elements, e.g. lateral locks, longitudinal locks, PDUs, which together weigh a great deal, have to be provided for the various configurations of the cargo deck.

Based on EP 1 179 472 A2, some embodiments provide a lateral guide for a cargo deck, said deck enabling a plurality of different configurations, said guide being rugged, easy to operate and, when fitted, resulting in a cargo deck with a low weight. In addition, the intention is to provide a corresponding lateral guide assembly and a corresponding cargo deck.

### SUMMARY OF THE INVENTION

In some embodiments a lateral guide for guiding cargo items, in particular containers and/or pallets, in an aircraft whereby the lateral guide comprises:

a mounting frame extending in the longitudinal direction;
at least one lateral guide device having a sliding carriage whereby the lateral guide device is movably supported in the mounting frame in the longitudinal direction, the sliding carriage having at least one guide roller for supporting the cargo items.

Lateral guides in aircraft are usually used for guiding cargo items in the aircraft's longitudinal direction (from nose to tail or from tail to nose). During the flight they absorb forces transverse to the longitudinal direction and hold cargo items in their position. The guide rollers grip the cargo items from below and support them. They enable easy, low-friction transport of the cargo items within the cargo hold.

The lateral guide device in some embodiments, carries out the actual guiding and holding function of the lateral guide, to be movably supported in a mounting frame. The lateral guide device can thus take up various positions in order to hold and guide cargo items with different dimensions. As a result, it is possible to save on numerous lateral guide devices which have to be arranged at different positions within the cargo deck. The lateral guide device can preferably be moved with the help of a sliding carriage which is movably supported in the mounting frame. This sliding carriage has at least one guide roller which makes transporting the cargo items easier. This guide roller therefore adopts various positions as does the lateral guide device. Due to the movable support of the guide roller, it is possible to save on a plurality of guide rollers. In addition, modern cargo decks are so densely populated with functional elements (e.g. lateral guides, guide rollers, locking claws, PDUs) that it is often difficult to find the right place for the necessary functional elements on the cargo deck. Due to the targeted saving on guide rollers and lateral guide devices according to the invention, it is possible to design cargo decks that facilitate an even greater number of different configurations.

The lateral guide device and the guide roller are preferably coupled to each other in such a way that they can be moved simultaneously. In this respect, reconfiguration of the cargo deck is also significantly easier than was the case with conventional systems.

It is possible to design the lateral guide according to the invention in such a manner that the mounting frame extends obliquely to the aircraft's transverse direction. For example, the longitudinal direction of the mounting frame may run at a 45° angle to the aircraft's transverse direction. The rotational axis of the guide roller is preferably aligned in such a manner that it is essentially parallel to the aircraft's transverse direction such that the cargo items can be transported efficiently from nose to tail or from tail to nose of the aircraft. In a preferred embodiment, the at least one guide roller is rotatably mounted in the sliding carriage about a rotational axis whereby the guide roller is arranged in such a manner in the sliding carriage that the rotational axis runs essentially parallel to the longitudinal direction of the mounting frame and thus parallel to the aircraft's transverse direction.

The lateral guide may comprise at least one fixing device for fixing the lateral guide device in at least two different positions in the mounting frame. Theoretically, it would be conceivable to design the lateral guide according to the invention such that it can be moved within an area in which it has no functional effect during loading and unloading. In a different configuration, it could adopt its guiding position. However, the lateral guide device can preferably be fixed in a plurality of positions such that it can interact with the cargo items in different configurations of the cargo deck.

The fixing device may comprise latch elements and mating latch elements at defined positions in the mounting frame. Suitably designed latch elements and mating latch elements enable the lateral guide devices to take up predefined positions. These positions may be chosen in such a manner that it is possible to guide cargo items having specified standard dimensions. In this respect, these latch and mating latch elements make adopting a specific predefined configuration easier.

The fixing device may comprise axle stubs which are movably supported, preferably on or in the sliding carriage, for releasing the fixing device counter to a spring force. These axles stubs may preferably engage in drilled holes provided therefor and the lateral guide devices may be fixed in a specific position. Such fixing makes it possible to transmit forces acting on the lateral guide devices efficiently into the mounting frame and thus into the cargo deck. The spring force may be directed in such a manner that a sort of snap-in connection arises between the lateral guide device and the mounting frame such that the fixing device of the lateral guide devices fixes in predefined positions.

The lateral guide device may comprise a limit stop and/or a locking claw which is attached to the sliding carriage in such a manner that the limit stop or locking claw is pivotable from a raised working position into a lowered resting position. In this respect, it is possible that the limit stop or locking claw will not only adopt various functional positions in the lateral guide device in order to guide and hold the cargo items in it. In addition, the limit stop or locking claw may be lowered so that cargo items can travel over them. This makes it possible to guarantee other configurations of the cargo deck. For example, it may be possible to create a freight deck that has no guides and on which a vehicle can drive.

The limit stop or the locking claw may be rotatably mounted on the sliding carriage about a pivot axis whereby the pivot axis preferably forms that part of the fixing device via which forces arising during holding are transmitted into the mounting frame. In this respect, the pivot axis acts as a pivot joint and at the same time efficiently transmits the forces arising into the mounting frame when in the working position.

The pivot axis preferably has the axle stub previously referred to above.

The limit stop or locking claw may have oblique surfaces on at least one side to move the limit stop or locking claw out of the working position into the resting position when being travelled over by a cargo item in a direction that is different to a holding direction of the limit stop or locking claw.

The lateral guide device may be removably arranged on the mounting frame. The lateral guide can preferably be removed from the guide provided on the mounting frame at least one open end of said mounting frame. Thus it is possible to replace an existing lateral guide device with a different lateral guide device. Moreover, the lateral guide may be designed such that by removing at least one lateral guide device, it can be travelled over at least partly by cargo items. Therefore further configurations of the cargo deck also emerge.

The lateral guide device may include at least one locking claw for gripping the cargo items at least in sections.

The locking claw may be flexibly attached to the sliding carriage and/or the sliding carriage may be flexibly attached to the mounting frame. In this respect, it is possible to flexibly absorb forces acting on the locking claw and transmit them to the cargo deck via the mounting frame.

In some embodiments a lateral guide assembly whereby this lateral guide assembly comprises a plurality of lateral guides, such as have already been described, whereby the lateral guide devices of the individual lateral guides have a least one rail which is movably supported in the mounting frame by means of the sliding carriage. The rail may be rigidly connected to the individual sliding carriage of the individual lateral guides and may guide the cargo items.

The rail may have locking claws, preferably of types which differ from each other. As the cargo items differ not only in their lateral dimensions but also in their longitudinal dimensions, it is advantageous if the rail extends over longer sections. In this respect, appropriate functional elements, in particular locking claws, may be provided such that a suitable retainer is available for each cargo item. The locking claws may be arranged immediately above a relevant mounting frame or may be arranged offset in relation thereto. Therefore it is possible to select the position of the functional elements in the aircraft's longitudinal position regardless of the mounting frame's position. Moreover, a rail may accommodate a plurality of different locking claws which are preferably arranged at varying distances thereon.

Furthermore, in some embodiments means of a cargo deck having at least one of the lateral guide assemblies described and/or having at least one of the lateral guides described.

Further advantageous embodiments emerge from the dependent claims.

### BRIEF DESCRIPTION OF THE DRAWINGS

The invention will be described in greater detail in the following based on drawings. The figures show:

FIG. 1 a lateral view of a lateral guide having two lateral guide devices;

FIG. 2 a second lateral view of the lateral guide from FIG. 1;

FIG. 3 a plan view onto the lateral guide from FIG. 1;

FIG. 4 a perspective view of a plurality of lateral guides joined by means of a rail;

FIG. 5 a perspective view of the lateral guide from FIG. 1;

FIG. 6 a lateral view of a lateral guide having a lateral guide device;

FIG. 7 a plan view onto the lateral guide from FIG. 6;

FIG. 8 a longitudinal section through the lateral guide from FIG. 6;

FIG. 9 a perspective view of the lateral guide from FIG. 6;

FIG. 10 a front view of the lateral guide from FIG. 6.

### DETAILED DESCRIPTION

The same reference numerals are used in the following description for identical parts and parts acting in an identical manner.

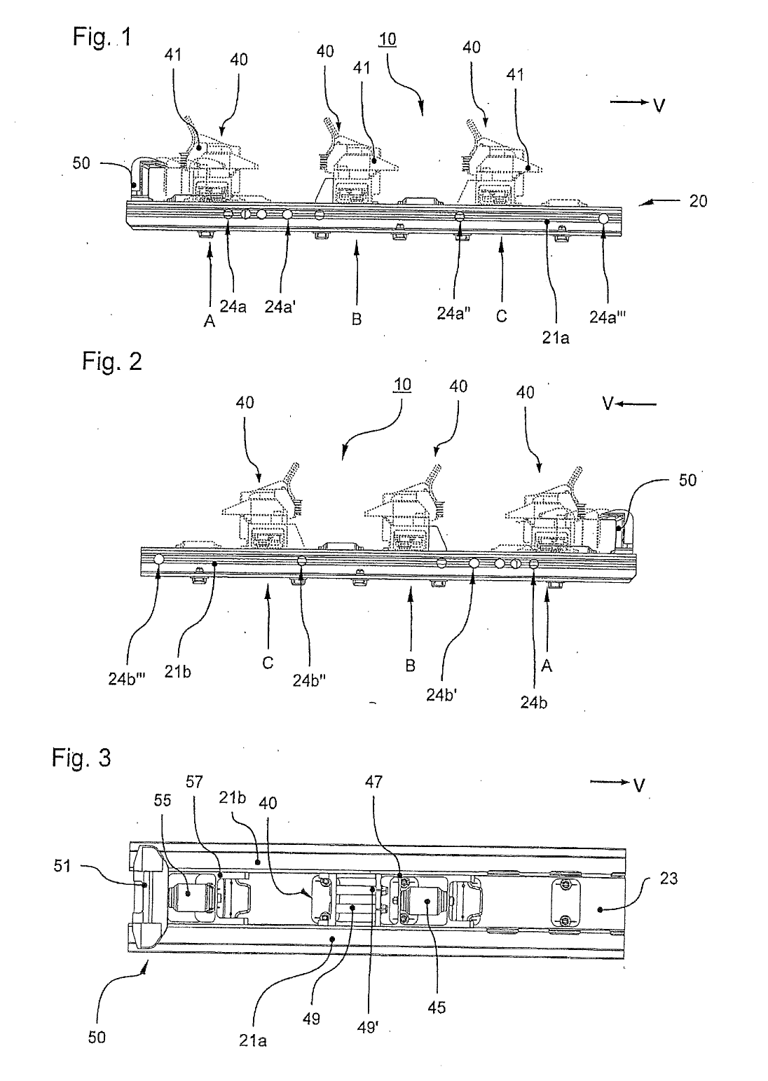

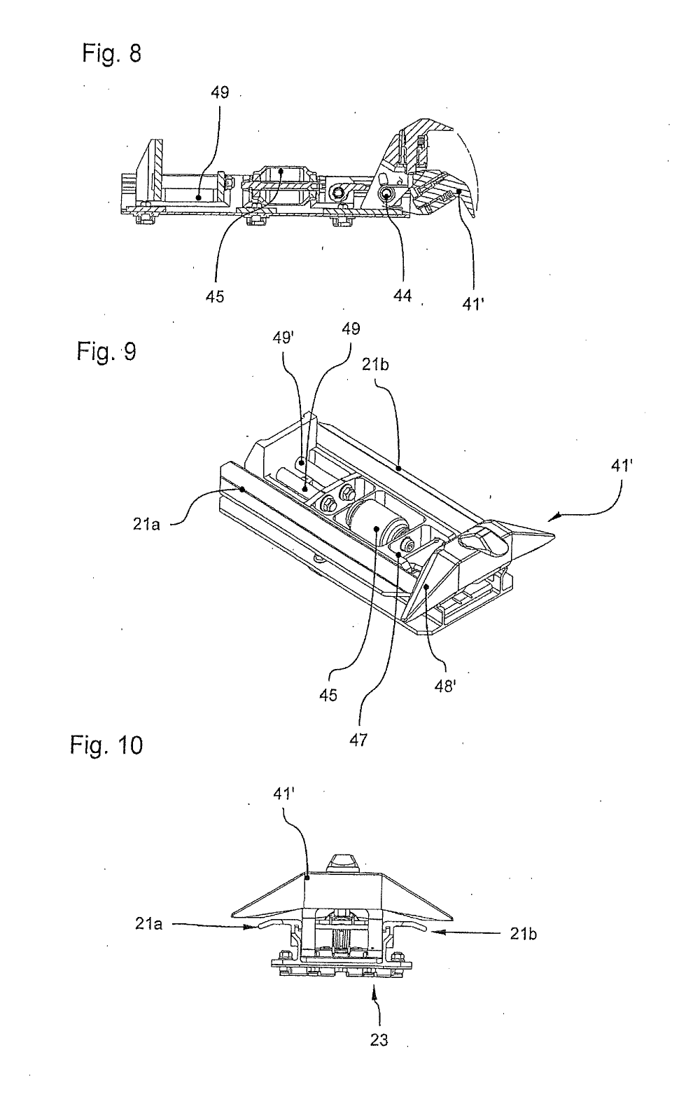

FIGS. 1 to 5 show a first embodiment of lateral guide 10 according to the invention, while a second embodiment can be seen from FIGS. 6 to 10.

Usually, a Cartesian coordinate system is used to provide specific directional information inside the aircraft. In this case, the x axis extends from tail to nose, the y axis runs transverse to the x axis and it lies essentially in the plane defined by the wings. The z axis is perpendicular to the x and y axis.

As illustrated in FIGS. 1 and 3, lateral guide 10 according to the invention has an elongated mounting frame 20 which extends in longitudinal direction v. Lateral guide 10 is preferably arranged in such a manner in the aircraft's deck that longitudinal direction v runs essentially parallel to the aircraft's transverse direction y. Lateral guide 10 is used to guide cargo items in the longitudinal direction (the aircraft's x direction) and acts as a limit stop for the cargo items so that they are aligned in the aircraft's y direction.

Therefore lateral guide 10 has mounting frame 20 which is attached to the cargo deck, a first lateral guide device 40 and a second lateral guide device 50. The dotted lines in FIGS. 1 and 2 illustrate lateral guide devices 40, 50 in different positions, that is in a first position A, a second position B and a third position C. Mounting frame 20, more precisely its lateral rails 21a, 21b, have drilled holes 24a, 24a′, 24a″, 24a′″, 24b, 24b′, 24b″, 24b′″ which make it possible to fix lateral guide devices 40, 50 in the various positions A, B, C.

Mounting frame 20 which is substantially u-shaped and has lateral rails 21a, 21b that are integrally joined to a mounting base 23 (cf. FIG. 3), thus makes it possible for lateral guide devices 40, 50 to be moved within it in longitudinal direction v. To fix first lateral guide device 40 in first position A, axle stubs provided for this purpose (cf. the axle stubs indicated schematically in FIG. 8 in a pivot axis 44), which form part of a fixing device, engage alternately in drilled holes 24a′, 24b′. In second position B, these axle stubs engage in drilled holes 24a″ and 24b″. In third position C, the axle stubs engage in drilled holes 24a′″ and 24b′″.

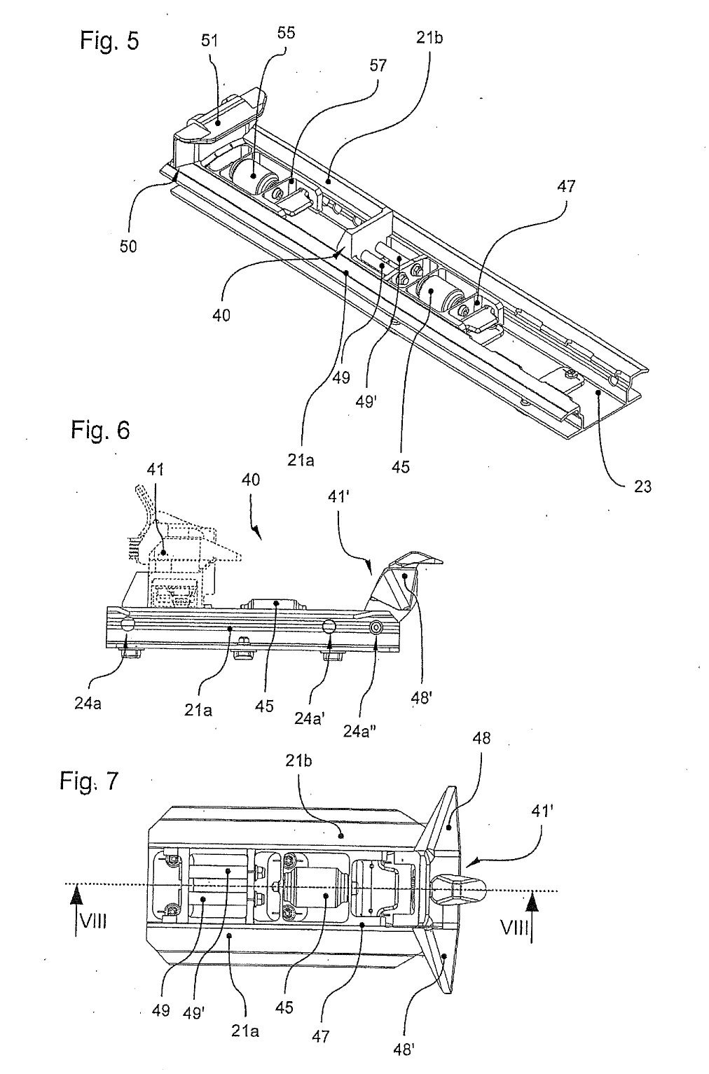

The movability of lateral guide devices 40, 50 is ensured by means of a first sliding carriage 47 or by means of a second sliding carriage 57 (cf. FIG. 5) whereby these sliding carriages 47, 57 are slidingly supported in guides of lateral rails 21a, 21b provided for this purpose.

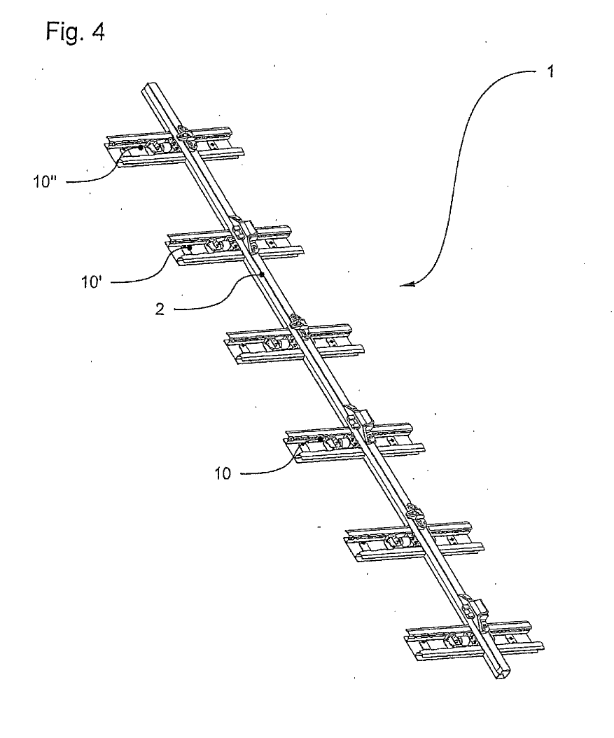

First lateral guide device 40 comprises first sliding carriage 47, spring supports 49, 49′, a guide rail 2 (cf. FIG. 4) which is flexibly supported on spring support 49, 49′, at least a first guide claw 41 and a first guide roller 45. First sliding carriage 47 forms a frame in which first guide roller 45 is rotatably mounted. First guide roller 45 may be rotated about a rotational axis and can therefore assist the transport of cargo items resting on it, preferably in the x direction. The rotational axis is essentially aligned along longitudinal axis v of mounting frame 20 such that the cargo items can be transported transversely to this longitudinal axis v. For this purpose, first guide roller 45, as can be seen from FIGS. 1 and 2, projects above mounting frame 20.

As can be seen from FIG. 5, second lateral guide device 50 has a second sliding carriage 57, a second guide roller 55 and a guide claw 51 firmly connected to second sliding carriage 57. In the lateral view, guide claw 51 together with mounting frame 20 also forms a u-shaped profile and is designed to grip lateral sections of the cargo items in order to lock them securely in position. Second guide claw 51 can also carry out a guiding function. Second sliding carriage 57 is also movably supported in mounting frame 20 and forms a frame for second guide roller 55. Second guide roller 55 is rotatably supported in this frame about a rotational axis which runs essentially coaxial to the rotational axis of first guide roller 45. Both lateral guide devices 40, 50 may essentially be moved independently of each other. It is possible to remove both first and second lateral guide device 40, 50 from mounting frame 20 by slipping them out at the open ends of mounting frame 20. In this sense, this already gives rise to numerous potential configurations. Therefore a guiding function may be performed either exclusively by first lateral guide device 40 or exclusively by second lateral guide device 50. In addition, first and second lateral guide device 40, 50 may adopt a plurality of different positions, that are predefined, for example, by drilled holes 24a, 24a′, 24a″, 24a′″, 24b, 24b′, 24b″, 24b′″. Thus second lateral guide device 50 engages for the fixing thereof in, for example, drilled holes 24a, 24b in the position illustrated in FIG. 5.

According to the invention, a plurality of described lateral guides 10 may be combined into a lateral guide assembly 1. Rail 2 joins first lateral guide devices 40 of individual lateral guides 10. Some of further lateral guides 10 bear the reference number 10′, 10″. As already explained, rail 2 is flexibly supported on sliding carriage 47 of individual lateral guides 10, 10′, 10″ and may be moved within mounting frame 20 in longitudinal direction v. Individual functional elements, e.g. a guiding claw 41, are fixed to the upper side of rail 2. It should be emphasised that the functional elements (in the aircraft's longitudinal direction) may be attached regardless of the position of mounting frame 20 such that, even with attachment of mounting frame 20 at regular intervals on the cargo floor, the functional elements may be positioned at varying intervals for holding cargo items with different dimensions. Therefore the example illustrated in FIG. 4 of lateral guide assembly 1 shows functional elements that are suitable for attaching military pallets and cargo containers used in civil aviation whereby the positions of locking claw or guiding claw 41 vary.

A further exemplary embodiment of a lateral guide 10 according to the invention may be seen from FIG. 6. Mounting frame 20 is made up, as is mounting frame 20 already described previously, of two lateral rails 21a, 21b and a mounting base. Mounting frame 20 is significantly shorter than that according to the exemplary embodiment of FIGS. 1 to 5. Only one lateral guide device 40 is movably supported in this embodiment. As can be seen from FIGS. 6 to 9, this lateral guide device 40 has a first guide claw 41 and a second guide claw 41′. First guide claw 41 is designed essentially identical to first guide claw 41′ according to the exemplary embodiment of FIGS. 1 to 5 and arranged on sliding carriage 47. Second guide claw 41′ is rotatably attached to sliding carriage 47 and may be pivoted from a working position (cf. FIGS. 6, 7, 9 and 10) into a resting position (indicated in FIG. 8). Cargo items can travel over guide claw 41′ in the resting position.

Lateral guide device 40 according to the second exemplary embodiment also comprises a guide roller 45 which is arranged in sliding carriage 47. The pivot joint of second guide claw 41′ is attached at one end of sliding carriage 47 and first guide claw 41′ is located at the other end. Overall, entire lateral guide 10 may be moved within frame 20 as a unit. Lateral rails 21a, 21b of lateral guide device 40 also have drilled holes 24a, 24a′, 24a″ for fixing sliding carriage 47 in predefined positions. In one position (cf. FIG. 6), second guide claw 41 is located so close to the end of mounting frame 20 that the claw can be folded down forwards into the resting position. In other positions of lateral guide device 40, the shoulders of second guide claw 41′ rest with oblique surfaces 48, 48′ on lateral rails 21a, 21b such that forces acting on second guide claw 41′ are transmitted into lateral rails 21a, 21b.

Oblique surfaces 48, 48′ are preferably arranged in such a manner that they connect operatively with cargo items that approach second guide claw 41′ laterally such that second guide claw 41′ is depressed into the resting position.

In a preferred exemplary embodiment, second guide claw 41′ rotates about a pivot axis 44 which has axles stubs in its interior that are simultaneously used to fix lateral guide 10 to mounting frame 20 (cf. the cross-section according to FIG. 8). This pivot axis 44 preferably also comprises at least one spring assembly which pretensions second guide claw 41′ into the working position such that it returns to its starting position after second guide claw 41′ has been travelled over by a cargo item.

Lateral guides 10, 10′, 10″ were described previously in which one or two lateral guide devices 40, 50 were movably supported in a mounting frame 20. For the person skilled in the art working in this field, it should be obvious that according to the invention a plurality of lateral guide devices 40, 50 can be supported in a mounting frame 20. In addition, it should be clear to the person skilled in the art working in this field that the length of mounting frame 20 can be adjusted at will to the requirements specified.

In the preceding embodiments, mainly guide claws 41, 41′, 51 were described which are arranged as functional elements on sliding carriage 47, 57. It is possible here to provide other functional elements such as a limit stop on sliding carriage 47, 57. Moreover, an embodiment was explained in which sliding carriages 47, 57 accommodate a guide roller 45, 55. It should be clear that sliding carriages 47, 57 may be fitted with any number of guide rollers 45, 55.

Moreover, the preceding embodiments are such embodiments in which mounting frames 20 are arranged transverse to the aircraft's longitudinal direction—that is in the y direction. It should easily be possible for the person skilled in the art working in this field to redesign lateral guide devices 40, 50 in such a manner that any alignment of mounting frame 20 is possible. Diagonal movement of sliding carriages 47, 57, for example, would be conceivable.

### REFERENCE NUMERALS

1 Lateral guide assembly
2 Guide rail
10, 10′, 10″ Lateral guide
20 Mounting frame
21a, 21b Lateral rail
23 Mounting rail base
24a, 24a′, 24a′″, 24a′″,
24b, 24b′, 24b″, 24b′″ Drilled hole
40 First lateral guide device
41, 41′ Guide claw
44 Pivot axis
45 First guide roller
47 First sliding guide carriage
48, 48′ Oblique surfaces
49, 49′ Spring support
50 Second lateral guide device
51 Second guide claw
55 Second guide roller
57 Second sliding carriage
v Longitudinal direction of the mounting frame

What is claimed is:

1. A lateral guide for guiding cargo items, in an aircraft, comprising:
a mounting frame extending in the longitudinal direction (v);
at least one lateral guide device having a sliding carriage, wherein the lateral guide device is movably supported in the mounting frame in the longitudinal direction (v), whereby the sliding carriage has at least one guide roller for supporting the cargo items.

2. A lateral guide according to claim 1, wherein, the at least one guide roller is rotatably supported about a rotational axis in the sliding carriage whereby the guide roller is arranged in such a way in the sliding carriage that the rotational axis runs essentially parallel to the longitudinal direction (v).

3. A lateral guide according to claim 1 wherein at least one fixing device for fixing the lateral guide device in at least two different positions (A, B, C) in the mounting frame.

4. A lateral guide according to claim 1 wherein, the fixing device comprises latch elements and mating latch elements at defined positions in the mounting frame.

5. A lateral guide according to claim 1 wherein, the fixing device comprises axle stubs which are movably supported, preferably on or in the sliding carriage, for releasing the fixing device, in particular counter to a spring force.

6. A lateral guide according to claim 1 wherein, the lateral guide device comprises a limit stop or a locking claw which is attached to the sliding carriage in such a manner that the limit stop or locking claw is pivotable from a raised working position into a lowered resting position.

7. A lateral guide according to claim 6, wherein the limit stop or the locking claw is rotatably mounted on the sliding carriage about a pivot axis whereby the pivot axis forms that part of the fixing device via which forces arising during holding are transmitted into the mounting frame.

8. A lateral guide according to claim 7, wherein the pivot axis comprises axle stubs which are movably supported for releasing the fixing device counter to a spring force.

9. A lateral guide according to claim 6, wherein the limit stop or locking claw has oblique surfaces on at least one side for moving the limit stop or locking claw out of the working position into the resting position when being driven over by a cargo item in a direction that is different to a holding direction of the limit stop or locking claw.

10. A lateral guide according to claim 1, wherein the lateral guide device is removably arranged on the mounting frame.

11. A lateral guide according to claim 1, wherein the lateral guide device comprises at least one locking claw for gripping the cargo items at least in sections.

12. A lateral guide according to claim 1, wherein at least one of either:
the locking claw is flexibly attached to the sliding carriage and the sliding carriage is flexibly attached to the mounting frame.

13. A lateral guide assembly, comprising a plurality of lateral guides according to claim 1, wherein the lateral guide devices comprise at least one rail which is movably supported in the mounting frame by means of the sliding carriage.

14. A lateral guide assembly according to claim 13, wherein the locking claws are arranged on the rail.

15. A cargo loading deck having at least one lateral guide assembly according to claim 13 and/or having at least one lateral guide.
